(19) United States
(12) Patent Application Publication
(10) Pub. No.: US 2005/0195087 A1
(43) Pub. Date: Sep. 8, 2005

(54) Air-in-line detector with warning device

(76) Inventors: Holly Rebecca Thompson, Auburn, CA (US); Margaret Anne De Marcaida, Towson, MD (US)

Correspondence Address: Holly R. Thompson, 15560 Ponderosa Ln., Auburn, CA, 95603, US

(21) Appl. No.: 10/792,986

(22) Filed: Mar. 4, 2004

(51) Int. Cl. G08B 21/00

(52) U.S. Cl. 340/603; 340/619; 250/559.42; 250/577

(57) ABSTRACT

Air-in-line sensors utilize infra-red emitter and detector pairs to monitor the presence or absence of air in tubing typically containing soda syrup. Wireless warning devices, activated when air is detected in soda tubing, can be paired to a specific sensor or all sensors so as to indicate respectively the depletion of a specific soda dispenser or one of several dispensers. This is accomplished through the use of uniquely encoded radio frequency transmissions.

### CROSS REFERENCE TO RELATED APPLICATION

Not Applicable

### FEDERALLY SPONSORED RESEARCH

Not Applicable

### SEQUENCE LISTING OR PROGRAM

Not Applicable

### FIELD OF THE INVENTION

The present invention relates to air-in-line detectors useful in medical, foodservice, and other commercial applications, and in particular detectors that employ infrared sensors, wireless warnings or both.

### BACKGROUND OF THE INVENTION

Methods for detecting air or gas bubbles within a transparent, liquid-conducting tubing are not new; a variety of solutions addressing this issue are documented in the prior art references provided. The majority of air-in-line detection systems relate to the medical industry and are typically used to monitor the transmission of fluids into a patient's body.

Most such systems incorporate one or more optical emitter-detector pairs placed around the tubing that observe the transmission, absorption, reflection, or refraction of light energy radiated through the tubing and its contents. Because gas and liquid transmit, absorb, reflect, and refract significantly different amounts of light energy, the optical detectors are able to distinguish between the presence of gas and liquid in transparent tubing.

More recent patents in the field have introduced increasingly accurate and reliable ways of distinguishing between gas and liquid: U.S. Pat. No. 6,531,708 B1, Malmstrom et al. and U.S. Pat. No. 5,672,887, Shaw et al. improve results by deforming the tubing while U.S. Pat. No. 4,829,448, Balding et al. and U.S. Pat. No. 5,680,111, Danby et al. attempt to reduce the number of false readings by increasing the number of emitter-detector pairs or the number and placement of optical detectors.

While some of these devices provide a local warning or signal when air or gas is detected in the tubing, none are able to warn people wirelessly from a distance. Furthermore, none of these detectors are able to monitor multiple lines of fluid-conducting tubing and provide a warning capable of distinguishing between them. Additionally, many of the preexisting designs are overly complex and employ more components than necessary, increasing the likelihood of a system failure due to individual part failure.

The need for a wireless warning is particularly prevalent in the quick-service restaurant industry where syrup dispensers are concealed and restaurant employees are too busy to monitor syrup availability.

### SUMMARY OF THE INVENTION

In a first embodiment of this invention, a sensor is provided for detecting the presence of gas in a fluid-conducting tubing comprising an electromagnetic radiation source, a source for detecting emitted radiation and generating an electrical signal, and components capable of distinguishing between electrical signals and transmitting a warning via a remote device.

The primary object of this invention is therefore not simply to detect the presence of gas in fluid-conducting tubing, but to provide in a first embodiment a wireless warning, taking on a single or multiple forms, to one or more people. Additionally, the preferred embodiment of this invention enables use in confined spaces unequipped with AC power outlets. The elimination of all constraints imposed by connective wires and power cables is accomplished in this embodiment through the use of battery power and means for reducing power consumption and extending battery life.

The preferred embodiment comprises a sensor whose elements can distinguish between gas and air and wirelessly activate a warning device, and a warning device whose elements are able to receive a wireless signal and provide a visual, audible, or otherwise desirable warning to a person or persons. This warning may comprise a light, sound, vibration, or other sensory stimulation; it may also be the activation of a pager or the appearance of text on a computer, PDA, or other text-supporting device.

Ideally, the battery operated sensor provides a housing into which a tubing is snap-fitted and within which is embedded an optical emitter-detector pair, preferably radiating and absorbing infrared energy. The emitter and detector should be substantially located 180 degrees opposite each other with the fluid-conducting tubing fitted between them.

The tubing and its contents, whether they be gas, liquid, or solid, all absorb some quantity of the energy radiated from the emitter; because the tubing will be present in all conditions its relative absorption is considered negligible. Gasses and liquids, however, absorb significantly different amounts of energy, allowing the detector to distinguish between gas and liquid by the amount of energy it detects.

When a gas bubble within the fluid-conducting tubing passes between the emitter and detector it causes a change in the absorption and therefore transmission of the radiated energy; the resulting electrical state change triggers the transmission of a wireless signal. Preferably, this signal is encoded so that it is only detected by those warning devices paired with the transmitting sensor. The receipt of this wireless signal by a paired device causes the warning device to initiate the desired warning; in the preferred embodiment this warning is the illumination of an LED. In this manner, multiple tubes containing different liquids can be monitored simultaneously, providing users with multiple distinct warnings in the case of simultaneous detection. Warning devices should be labeled to indicate the corresponding fluid being monitored by the paired sensor.

It should be noted however, that warning devices can be paired to multiple sensors, becoming universal. Thus, in applications where multiple lines of fluid-conducting tubing must be monitored, universal warning devices can be used to signal employees that one or more of the lines contains air and should be checked on while other paired warning devices identify specific lines with air bubbles.

### BRIEF DESCRIPTION OF THE DRAWINGS

FIG. 1 is a schematic of the typical environment in which the preferred embodiment of the invention will be used;

FIG. 2 is a cross-sectional view of sensor 10a taken along the line B-B of FIG. 3;

FIG. 3 is a cross-sectional view of sensor 10a taken along the line A-A of FIG. 2;

FIG. 4 is a schematic of the main components of fluid detector 21a within sensor 10a which is used to detect the presence or absence of fluid in soda tubing 5a;

FIG. 5 is a cross-sectional view of warning device 40a taken along the line C-C of FIG. 1;

FIG. 6 is a block diagram of sensor 10a;

FIG. 7 is a block diagram of warning device 40a;

FIG. 8a is a graph of the signal 29a sent by timer 20a to fluid detector 21a;

FIG. 8b is a graph of the signal 7a transmitted by sensor 10a.

### DETAILED DESCRIPTION OF THE PREFERED EMBODIMENT

The present manifestation of the invention is designed for application in the quick-service restaurant industry and provides a direct, wireless warning to soda fountain users and establishment staff when soda syrup supplying self-service fountains runs out. The invention's most general form utilizes optical sensors to detect gas bubbles traveling through fluid-conducting tubing and provides a wireless warning, visible, audible or otherwise, when gas bubbles travel past the sensor. The specific application described herein monitors the flow of soda syrup exiting a syrup dispenser and signals establishment staff and/or customers when a syrup dispenser is empty via wireless transmission to one or many warning devices.

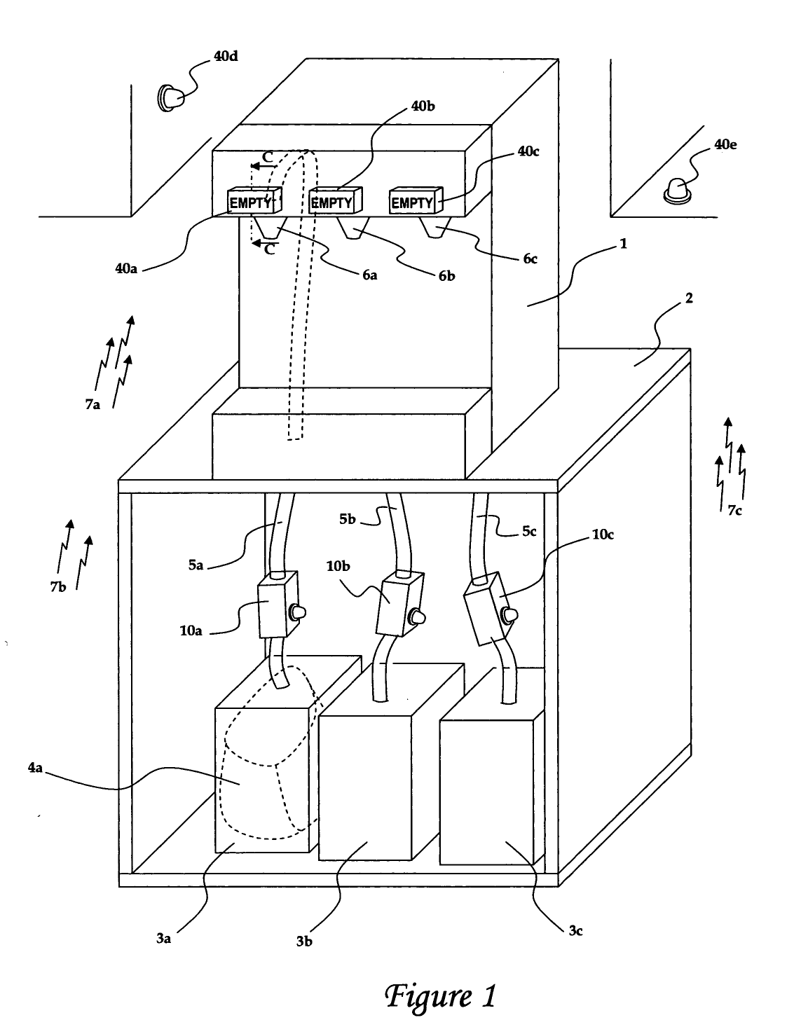

FIG. 1 illustrates a typical application of the preferred embodiment of this invention. In most quick-service restaurants, a self-service soda fountain 1 sits atop a counter 2 under which are stored a number of syrup dispensers 3a, 3b, and 3c that supply fountain 1 with soda syrup. For example, soda tubing 5a connects to cardboard syrup dispenser 3a via a valve protruding from plastic bag 4a containing the syrup which is housed in cardboard dispensing box 3a. Soda tubing 5a enters soda fountain 1 eventually mixing the syrup with water and CO₂, not shown, at fountain head 6a where the soda is dispensed.

As syrup is pulled from dispenser 3a, bag 4a contracts, decreasing in volume. Once bag 4a empties, a vacuum is created in tubing 5a, causing air to follow the last of the syrup up tubing 5a to fountain head 6a. The sudden cessation of syrup at fountain head 6a causes the fountain to sputter when actuated, delivering a mixture of water, CO₂, and air in place of syrup. Because syrup dispensers 3a, 3b, and 3c are typically stored in an enclosed cupboard under soda fountain 1 and counter 2 and cannot visually be inspected for low syrup content, neither customers nor employees have any warning that a given syrup is unavailable and a dispenser needs to be replaced. The preferred embodiment of this invention detects the presence of empty dispensers via sensors such as 10a, 10b, and 10c and notifies customers and establishment staff of the condition via paired warning devices such as 40a, 40b, 40c, respectively, and universal warning devices such as 40d and 40e shown as light emitting diodes.

Sensor 10a is snap-fitted to soda tubing 5a near connected syrup dispenser 3a such that air entering soda tubing 5a when dispenser 3a empties will be detected quickly. All additional sensors such as 10b and 10c are similarly installed. Paired warning devices such as 40a, 40b, and 40c should be placed above soda fountain heads 6a, 6b, and 6c corresponding to the syrup being monitored by the respective paired sensors 10a, 10b, and 10c. Additionally, universal warning devices such as 40d and 40e can be placed anywhere in the establishment. Upon detection of air in soda tubing 5a sensor 10a begins transmitting its uniquely encoded signal 7a. Signal 7a is received by paired warning device 40a and all universal warning devices such as 40d and 40e which then initiate the desired warning, preferably the illumination of an LED.

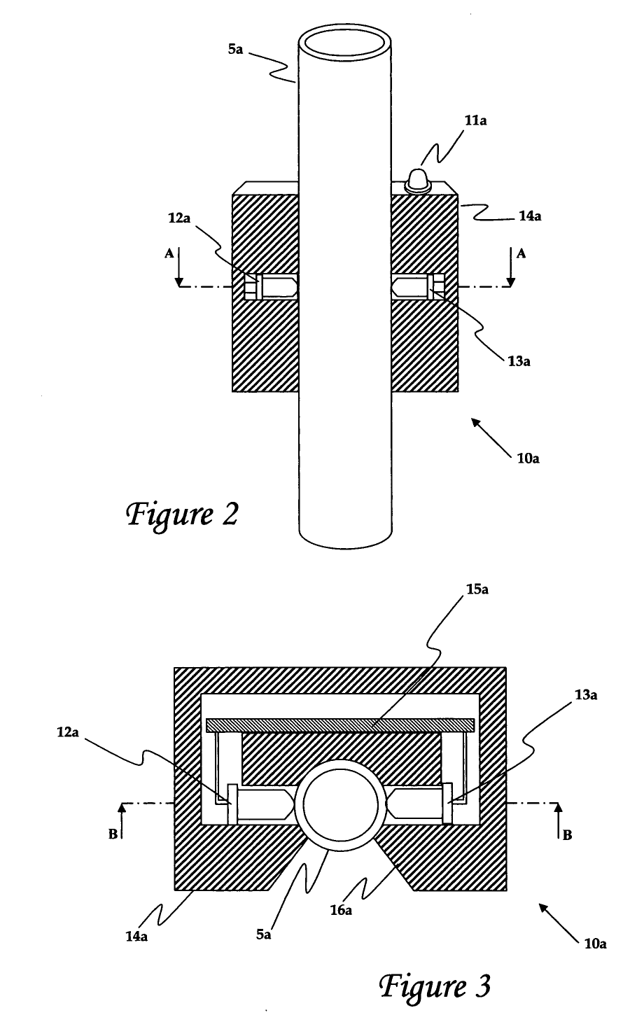

FIG. 2 reveals a cross-sectional view of sensor 10a taken along the line B-B of FIG. 3. This view exposes optical emitter 12a and optical detector 13a which are oriented at substantially 180 degrees opposite each other with soda tubing 5a located between them. Optical emitter 12a and optical detector 13a are enclosed in plastic housing 14a which contains all components comprising sensor 10a. Indicator 11a is preferably an LED located on the exterior of housing 14a that provides a visual indication of syrup depletion.

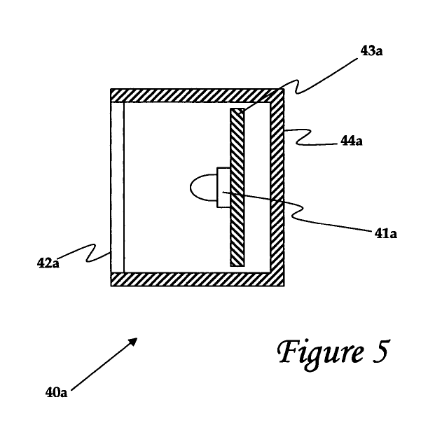

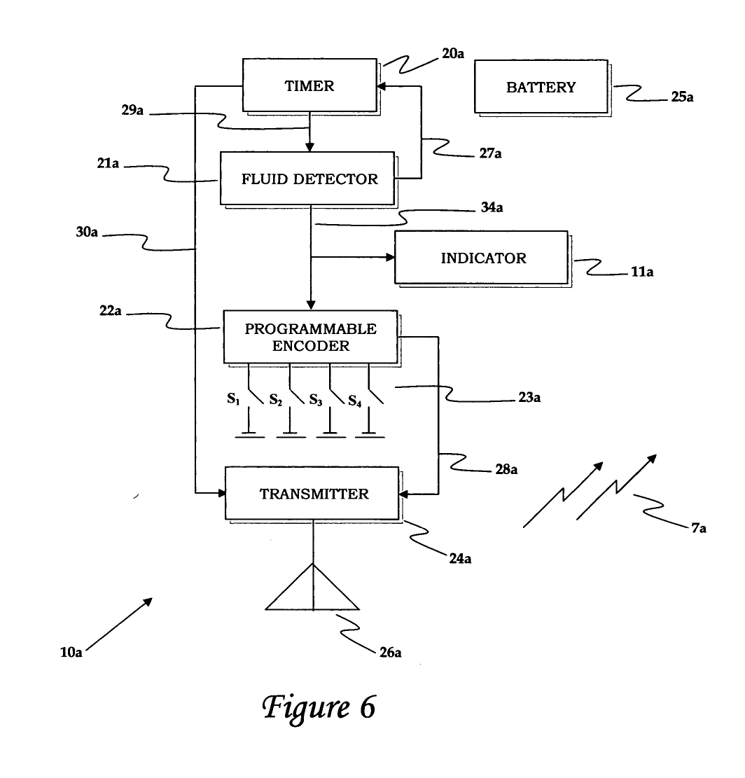

FIG. 3 details the cross-sectional view of sensor 10a taken along the line A-A of FIG. 2. This view depicts the preferable snap-fit design of housing 14a via trench 16a. Optical emitter 12a and optical detector 13a are connected to circuit board 15a whose components are detailed in FIG. 5. All sensors such as 10a, 10b, and 10c are constructed in a similar fashion differing only in their encoded transmissions 7a, 7b, and 7c which are further described in FIG. 6.

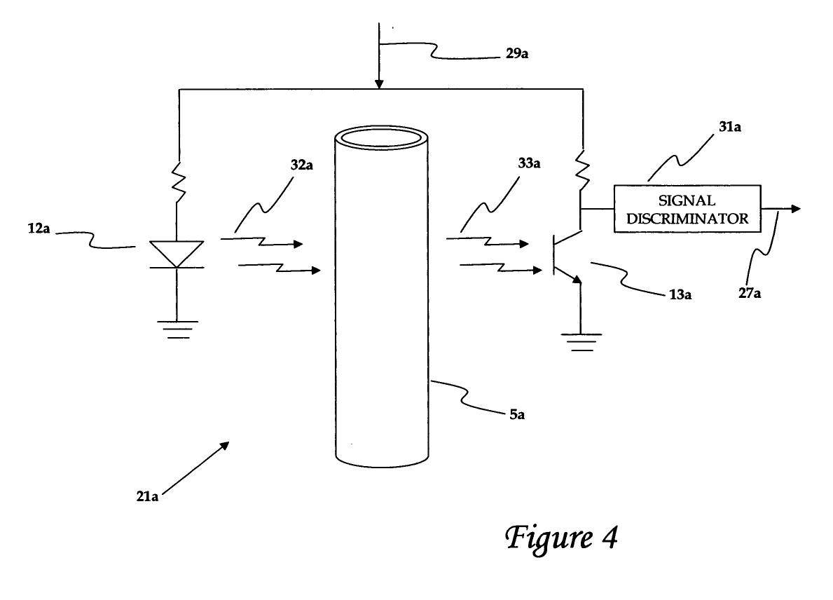

FIG. 4 is a schematic of the main components of fluid detector 21a within sensor 10a which is used to detect the presence or absence of fluid in soda tubing 5a. Preferably, optical emitter 12a radiates infrared energy 32a and optical detector 13a detects infrared energy 33a. Optical emitter 12a and optical detector 13a are activated by pulse signal 29a. Connected to optical detector 13a is signal discriminator 31a which discriminates between low level signals outputted from optical detector 13a when fluid is present in tubing 5a and high level signals outputted when air is present in tubing 5a. Signal discriminator 31a transmits signal 27a when this electrical state change occurs.

A cross-sectional view of warning device 40a taken along the line C-C from FIG. 1 is depicted in FIG. 5. Preferably, front face 42a of warning device 40a is constructed from a transparent material on which the word EMPTY is printed. Because the preferred warning of warning device 40a is the illumination of the word EMPTY on front face 42a, LED 41a enclosed in plastic housing 44a illuminates when activated by circuit board 43a.

FIG. 6 shows a block diagram of the elements comprising sensor 10a. Fluid detector 21a is responsive to timer 20a via pulse signal 29a intended to conserve power from battery 25a. Signal 30a sent from timer 20a to transmitter 24a is only activated upon receipt of signal 27a from fluid detector 21a. Indicator 11a and programmable encoder 22a are also responsive to fluid detector 21a via signal 34a. Programmable encoder 22a utilizes switch matrix 23a to uniquely encode serial data stream 28a sent to transmitter 24a. The number of switches comprising switch matrix 23a determines the number of unique codes available to distinguish between multiple sensors such as 10a and 10b and multiple warning devices such as 40a and 40b. Transmitter 24a is responsive to programmable encoder 22a and timer 20a and transmits RF signal 7a via antenna 26a. RF signal 7a has a modulated signal corresponding to the unique code determined by switch matrix 23a. All sensors such as 10a, 10b, and 10c are constructed in a similar fashion differing only in the settings of their respective switch matrices 23a, 23b, and 23c. Thus, sensor 10a may have switches S₁, S₂, and S₃ closed yielding the encoded transmission 7a, whereas sensor 10b may have switches S₂, S₃, and S₄ closed yielding the encoded transmission 7b.

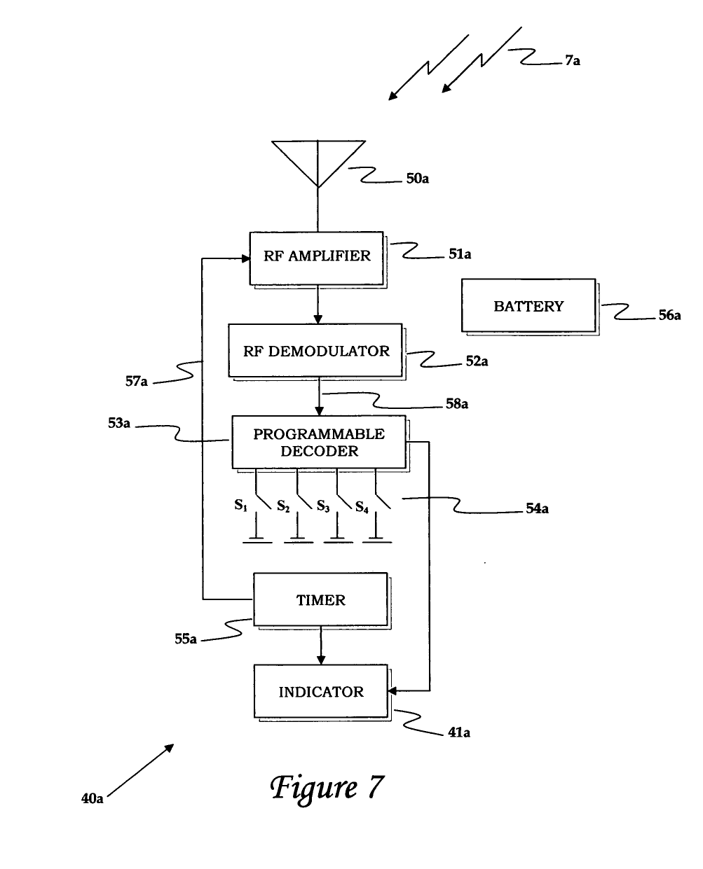

The block diagram illustrated in FIG. 7 depicts the components comprising the paired warning device 40a from FIG. 1. Antenna 50a connects to RF amplifier 51a; RF amplifier 51a is further responsive to pulse signal 57a controlled by timer 55a. Thus, RF amplifier 51a is periodically activated, conserving power from battery 56a. RF demodulator 52a is responsive to RF amplifier 51a. Programmable decoder 53a is responsive to RF demodulator 52a and utilizes switch matrix 54a to decode demodulated signal 58a. Indicator 41a is responsive to programmable decoder 53a. All paired warning devices such as 40a, 40b, and 40c and universal warning devices such as 40d and 40e are constructed in a similar fashion differing only in the settings of their respective switch matrices 54a, 54b, 54c, 54d, and 54e.

Switch matrices 54a, 54b, and 54c of paired warning devices 40a, 40b, and 40c respectively should be set to receive only specific encoded signals 7a, 7b, or 7c respectively; whereas switch matrices 54d, and 54e of universal warning devices 40d and 40e should be set to receive any and all encoded signals 7a, 7b, and 7c. For example, the settings of switch matrix 23a within sensor 10a must match the settings of switch matrix 54a within paired warning device 40a for the warning to be activated. All switch matrices 23a, 23b, 23c, 54a, 54b, 54c, 54d, and 54e should be set manually prior to installation of sensors 10a, 10b, and 10c warning devices 40a, 40b, 40c, 40d, and 40e.

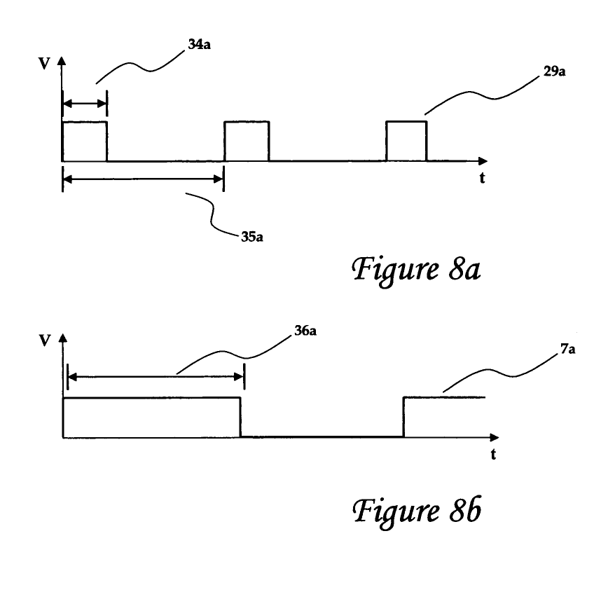

In operation, syrup is drawn from dispenser 3a, causing bag 4a to deplete until devoid of syrup. After the last of the syrup from bag 4a is drawn into soda tubing 5a, a vacuum is created behind the syrup in tubing 5a and air is drawn up tubing 5a behind the syrup. Meanwhile, to conserve power from battery 25a, preprogrammed timer 20a activates fluid detector 21a periodically via signal 29a with a typical pulse rate of approximately 5 pulse/sec having a substantially defined duty cycle such as shown in FIG. 8a. However, programmed pulse rate 34a and duty cycle 35a from FIG. 8a can be any desired length. When air being drawn up soda tubing 5a passes through sensor 10a, optical detector 13a detects the change in absorption of energy being radiated from optical emitter 12a as compared with the amount of energy detected when soda tubing 5a contains syrup. The resulting electrical state change is detected by signal discriminator 31a which indicates via signal 27a that timer 20a should activate transmitter 24a. Timer 20a activates transmitter 24a via signal 30a with a pulse rate 36a long enough that a complete code sequence 7a can be transmitted as shown in FIG. 8b. Simultaneously, fluid detector 21a activates indicator 11a and programmable encoder 22a via signal 34a. Programmable encoder 22a, preferably Holtek's 2¹² series HT12A, uniquely encodes serial data stream 28a and sends it to transmitter 24a. Transmitter 24a, in response to timer signal 30a and serial data stream 28a, transmits RF signal 7a via antenna 26a from sensor 10a. Transmitter 24a is preferably RFM's TX5000 433.92 MHz Hybrid Transmitter.

Encoded signal 7a is received by antennas 50a, 50d, and 50e of paired warning device 40a and universal warning devices 40d and 40e respectively. Within paired warning device 40a, RF amplifier 51a amplifies encoded signal transmission 7a received by antenna 50a to sufficient signal strength for RF demodulator 52a to demodulate signal 7a. Preferably, Micrel's integrated circuit MICRF001 encompasses both RF amplifier 51a and RF demodulator 52a. The demodulated signal 58a is then passed to programmable decoder 53a, preferably Holtek's 2¹² series HT12D which matches Holtek's 2¹² series HT12A encoder. Programmable decoder 53a is responsive to switch matrix 54a; thus, if the decoded signal matches decoder address 54a, decoder 53a activates the desired warning of indicator 41a, preferably the illumination of an LED. Since warning devices 40b and 40c do not have the same respective switch matrix settings 54b and 54c as switch matrix 23a of sensor 10a, indicators 41b and 41c are not activated. The action of all paired warning devices such as 40a, 40b, and 40c and all universal warning devices such as 40d and 40e is the same as that described for 40a.

Should two dispensers 3a and 3c empty concurrently, sensors 10a and 10c would initiate the transmission of their respective encoded wireless RF signals 7a and 7c. Paired warning devices 40a and 40c would then activate the desired warning upon receipt of their respective signals 7a and 7c. In addition, all universal warning devices such as 40d and 40e placed around the establishment would initiate the desired warning upon receipt of either encoded signal 7a or 7c.

After an empty dispenser such as 3a has been replaced and syrup reenters soda tubing 5a, passing through sensor 10a, fluid detector 21a again detects the electrical state change caused by optical detector 13a detecting a difference in the absorption of energy 32a radiated from optical emitter 12a. Signal discriminator 31a again transmits signal 27a to timer 20a which deactivates transmitter 24a. The lack of signal 7a received by paired warning device 40a, and universal warning devices 40d and 40e causes said warning devices to deactivate their respective indicators 41a, 41d, and 41e, concluding the desired warning.

Various modifications of structure and operation are possible within the scope of the inventive concept; therefore, it is intended that the invention not be limited by the above description but rather defined by the following claims.

1. An apparatus for detecting the presence of a gas in a fluid-conducting tubing, comprising:
radiation source means for directing a radiation beam through a fluid conducting tubing;
receiving means for receiving a portion of said directed beam after it passes through said tubing, and for generating an electrical signal;
processing means for distinguishing between electrical signals corresponding to the presence of a liquid or a gas within said tubing; and
transmission means for providing a warning relative to said signal.

2. The apparatus of claim 1 wherein said fluid-conducting tubing comprises a transparent polymeric tubing.

3. The apparatus of claim 1 wherein said radiation source is an electromagnetic radiation source.

4. The apparatus of claim 1 wherein said radiation source is an infra-red source.

5. The apparatus of claim 1 wherein said fluid is selected from the group consisting of beverages and fuels.

6. The apparatus of claim 1 wherein said fluid is a liquid infusion for a patient.

7. The apparatus of claim 1 wherein said transmission means comprises a wireless transmitter for providing a signal to a remote signaling device.

8. The apparatus of claim 7 wherein said remote signaling device comprises elements selected from the group consisting of LEDs and beepers and vibrators.

9. The apparatus of claim 7 wherein said remote signaling device comprises a light.

10. The apparatus of claim 7 wherein said remote signaling device comprises an antenna for receiving a signal from said wireless transmitter.

11. The apparatus of claim 1 wherein said fluid-conducting tubing comprises at least two fluid-conducting tubes, and said apparatus is capable of independently detecting a gas in each of said tubes and providing a distinct warning signal for each of said tubes.

12. An apparatus for detecting the presence of a gas in a fluid-conducting tubing, comprising:
radiation source means for directing a radiation beam through a fluid-conducting tubing;
receiving means for receiving a portion of said radiation beam and providing a signal responsive to said received beam portion;
processing means for distinguishing between signals corresponding to the presence of a liquid and the presence of a gas in said fluid-conducting tubing; and
wireless transmitting means for transmitting a warning to a remote signaling device.

13. The apparatus of claim 12 wherein said fluid-conducting tubing comprises a portion of a soda dispensing system.

14. The apparatus of claim 12 wherein said beam comprises an infra-red radiation.

15. The apparatus of claim 12 wherein said gas comprises air bubbles.

16. A method of measuring a gas in a fluid-conducting tubing comprising:
directing a radiation beam through a fluid-conducting tubing;
receiving a portion of said radiation beam;
processing said received portion of said radiation beam, generating an electrical state responsive to same, and distinguishing between electrical states corresponding to the presence of a liquid and the presence of air; and
transmitting a signal based on said distinguished energy states to a separate device.

17. The method of claim 16 wherein said fluid-conducting tubing comprises a beverage dispenser.

18. The method of claim 16 wherein said fluid-conducting tubing comprises at least two tubes including separate fluids, said tubes independently monitored for the presence of a gas.

19. A beverage dispenser for dispensing a carbonated beverage comprising:
radiation source means for directing an infra-red beam through a fluid-conducting tubing;
receiving means for receiving a portion of said transmitted infra-red light;
processing means for distinguishing between electrical states corresponding to the presence of a liquid and the presence of air within said fluid-conducting tubing; and
means for transmitting a signal corresponding to said electrical states to a remote warning device.

20. The apparatus of claim 19 wherein said means for transmitting comprises a wireless transmitter.

21. An apparatus for remotely indicating the presence of a gas in a fluid-conducting tubing comprising:
means for indicating the presence of said gas in a fluid-conducting tube;
processing means for activating a warning when the presence of said gas is found in said fluid-conducting tube; and
transmitting means for transmitting a signal reflective of the presence of said gas in said fluid-conducting tubing; and
receiving means for receiving said signal wirelessly and for providing a visual or audio or vibratory warning signal, or any combination of the three.
